(19) United States
(12) Patent Application Publication
(10) Pub. No.: US 2017/0161760 A1
(43) Pub. Date: Jun. 8, 2017

(54) SYSTEMS AND METHODS FOR AN IN-VEHICLE SURVEY WITH GENERATED ROUTES

(71) Applicants: Hyundai America Technical Center, Inc., Superior Township, MI (US); Kia Motors Corporation, Seoul (KR); Hyundai Motor Company, Seoul (KR)

(72) Inventors: Chadd Price, Livonia, MI (US); Amanda Christiana, Ann Arbor, MI (US); Gregory Ardisana, Canton, MI (US)

(21) Appl. No.: 14/962,632

(22) Filed: Dec. 8, 2015

(51) Int. Cl. G06Q 30/02; G01C 21/36; G01C 21/34

(52) U.S. Cl. CPC G06Q 30/0203; G01C 21/3492; G01C 21/3691; G01C 21/3697

(57) ABSTRACT

The present disclosure provides for systems and methods to conduct a product or vehicle survey of a user with a vehicle. The survey can be administered using the vehicle's capabilities and remotely accessible hardware and software. A vehicle survey system can provide a survey route suitable to administer survey questions and determine which questions to ask such that the questions correlate with vehicle events.

### FIELD

The present disclosure relates to systems and methods of administering a vehicle survey with generated routes. In particular, the present disclosure provides a vehicle survey system containing survey questions correlated with events of interest. The present disclosure also provides methods to administer vehicle surveys along survey routes when the correlated event arises.

### BACKGROUND

Manufacturers and suppliers can improve their products by obtaining consumer feedback. To do this, they often send mass surveys via mail or e-mail for the consumers to fill out. A notable drawback of mailed surveys is that the surveyee is likely not using the target product (e.g. vehicle) while filling out the survey.

To provide feedback while the product is being used, manufacturers and suppliers can hire interviewers to conduct surveys when the customer is in the process of using a target product. However, hiring an interviewer may be expensive, and the process may be inconvenient for the user. Additionally, it can be hard to sample a high number of individuals when an interviewer must be present.

### BRIEF SUMMARY OF THE INVENTION

The invention may include any of the following embodiments in various combinations and may also include any other aspect described below in the written description or in the attached drawings. This disclosure provides systems and methods for conducting a survey of a user with a vehicle.

In a first embodiment, the method may include (1) determining if vehicle navigation is in progress on a path; (2) determining if the path has or meets a minimum requirement(s) for the survey, the minimum requirement being an event correlating with one or more survey questions; (3) when the path does not meet the minimum requirement for the survey, providing a first route meeting the minimum requirement for the survey; (4) selecting the path or the first route as a survey route; and (5) delivering the one or more survey questions while on the survey route.

In a second embodiment, the method includes (1) determining if the vehicle is moving on a common route; (2) determining if the common route has a minimum requirement for the survey, the minimum requirement being an event correlating with one or more survey questions; (3) when the common route does not to have the minimum requirement for the survey, providing a first route having the minimum requirement for the survey; and (4) selecting the common route or the first route as a survey route.

In a third embodiment, the method includes (1) determining if vehicle navigation is in progress on a path being a common route; (2) determining if the vehicle is moving on a common route; (3) determining if the path or the common route has a minimum requirement for the survey, the minimum requirement being an event correlating with one or more survey questions; (4) when neither the path nor the common route meet the minimum requirement, providing a first route having a minimum requirement for the survey; and (5) selecting one of the path, the common route and the first route as a survey route.

In any of the above embodiments, an event correlating to one or more survey questions may be a vehicle speed, a stop, a noise, an intersection, a speed zone, a road condition, another vehicle, a temperature, weather, time of day, traffic conditions, steering wheel angle, a yaw angle, vehicle angular velocity, a yaw rate, vehicle roll, global positioning system coordinates, a vehicle location, a vehicle vibration, a pothole, engine revolution per minute, a seat position, a mirror position, fuel consumption, and a roundabout. Generally, the correlating event may also be a vehicle condition, a road condition, and/or a route condition. In any of the above embodiments, the provided first route may be a circular route, a modified route, a new route, and a saved route.

Further, any of the above methods may include informing the user of a time requirement or a duration of the first route. Asking the user to accept the first route and take the survey may be included in the step of selecting the first route as the survey route. Determining if the event is triggered with one or more of sensors may be included after the step of providing a first route. The one or more sensors are in communication with the vehicle. The one or more sensors may be operable to measure one or more events.

Initiating the one or more survey questions correlating to the event may be included after the step of determining if the event is triggered with one or more of sensors. Receiving and storing user response with correlating information selected from the group consisting of vehicle information, user information, and event information, defining user data, may be included after the step of initiating the one or more survey questions. The user response may be a verbal, tactile, or gestural.

The user response may be received with a part of the vehicle, the part selected from the group consisting of an infotainment system, a screen, a surface, a button, a camera, and a recorder.

Any method discussed herein may include transmitting the user data after the step of receiving and storing user response with correlating information selected from the group consisting of vehicle information, user information, and event information. Further, any method may include the step of providing a second route being automatically generated, pausing the survey, or canceling the survey when the vehicle deviates from the first route after the step of providing a first route.

Survey questions may be input into a system by individuals with different entities. For example, the methods may include inputting a first survey question and a corresponding first event into a survey database by a first individual from a first entity. The survey database may be in communication with the vehicle. The methods discussed herein may also include inputting a second survey question and a corresponding second event into the survey database by a second individual from a second entity after the step of inputting a first survey question.

As one possible advantage of the vehicle survey discussed herein, the manufacturer, or intended third-party target for the survey data, can acquire real-time, accurate, and robust feedback from users of the product. Once collected, the manufacturer or third-party obtaining the data may categorize it and re-categorize it as needed to improve customer satisfaction and product performance (e.g. vehicle performance).

The present disclosure may be better understood by referencing the accompanying figures.

### BRIEF DESCRIPTION OF THE DRAWINGS

FIG. 1 depicts a flow chart of a method of performing a survey in accordance with one embodiment of the present disclosure;

FIGS. 2A-B depict a vehicle survey system to perform the method of FIG. 1;

FIG. 3 depicts a more detailed flow chart of the method of FIG. 1;

FIG. 4 depicts an exemplary map of a common route of the method of FIG. 1;

FIG. 5 depicts an exemplary map of a new route of the method of FIG. 1;

FIG. 6 depicts an exemplary map of a modified route of the method of FIG. 1;

FIG. 7 depicts an exemplary map of a circular route of the method of FIG. 1; and

FIG. 8 depicts an exemplary map of a combined route of the method of FIG. 1.

### DETAILED DESCRIPTION

The present disclosure will now be described more fully with reference to the accompanying figures, which show various embodiments. The accompanying figures are provided for general understanding of various embodiments and method steps. However, this disclosure may be embodied in many different forms. These figures should not be construed as limiting, and they are not necessarily to scale.

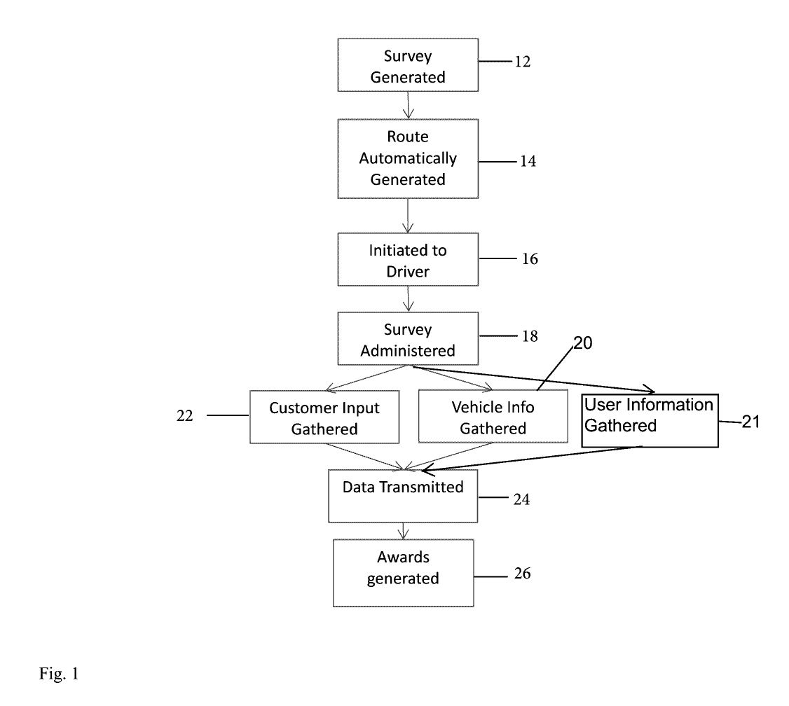

FIG. 1 depicts a method of carrying out the vehicle survey of the present disclosure. In box 12, the vehicle survey system (“system”) may generate a survey. As will be discussed further below, this survey may have one question or multiple questions, from one or multiple sources, depending on the information provided to the system. The survey could be administered along a path and/or a variety of possible routes that will be discussed further below.

Survey generation in box 12 may also include individuals providing survey questions with correlating or corresponding environmental situations and/or external conditions (“events”). For example, employees of a vehicle or vehicle parts manufacturer may generate survey questions correlated with situational events that a particular vehicle may encounter on the road or during use of vehicle. Such questions with a correlating event can be stored in a system storage or database.

After generating the survey, the system may proceed to box 14 where it may automatically generates a route based on the survey questions to be administered. In box 16, the survey may be initiated to the driver, passenger, or other user of the vehicle. Once the user agrees to take the survey, the method may proceed to box 18 where survey questions are administered. Survey questions may be administered through the vehicle's audio system, infotainment system, screens, and the like.

While the survey is administered, the system may collect various types of information to store as survey data or user data. First in box 22, the system may gather customer input or user response. Second in box 20, the system may gather vehicle information about the various events and conditions the vehicle encounters on the route.

The system may also collect user information, as in box 21. User information may include information regarding the user's physical condition or health, such as heartbeat, movement, height, weight, age, name, pulse, breathing, gender, race, nationality, and the like. Such information may be gathered by the system while the user is in the vehicle. User information may also be entered by the user into the system and/or received by external devices and computers in communication with the system. All of this information may be correlated and stored as user data. In box 24, the user data may be transmitted as desired (e.g. to various storage sources or third parties).

In box 26, the system may generate an award for the user or surveyee as an incentive to take this survey and further surveys. This step is optional. Some examples, of awards include money, product upgrades, points towards a point system, vehicle maintenance, and the like. In return, the manufacturer receives valuable information that can help improve product performance and user satisfaction with a vehicle. The manufacturer may obtain instant feedback that is more accurate, with a higher response rate, than mailing a mass survey or hiring an interviewer to ask survey questions.

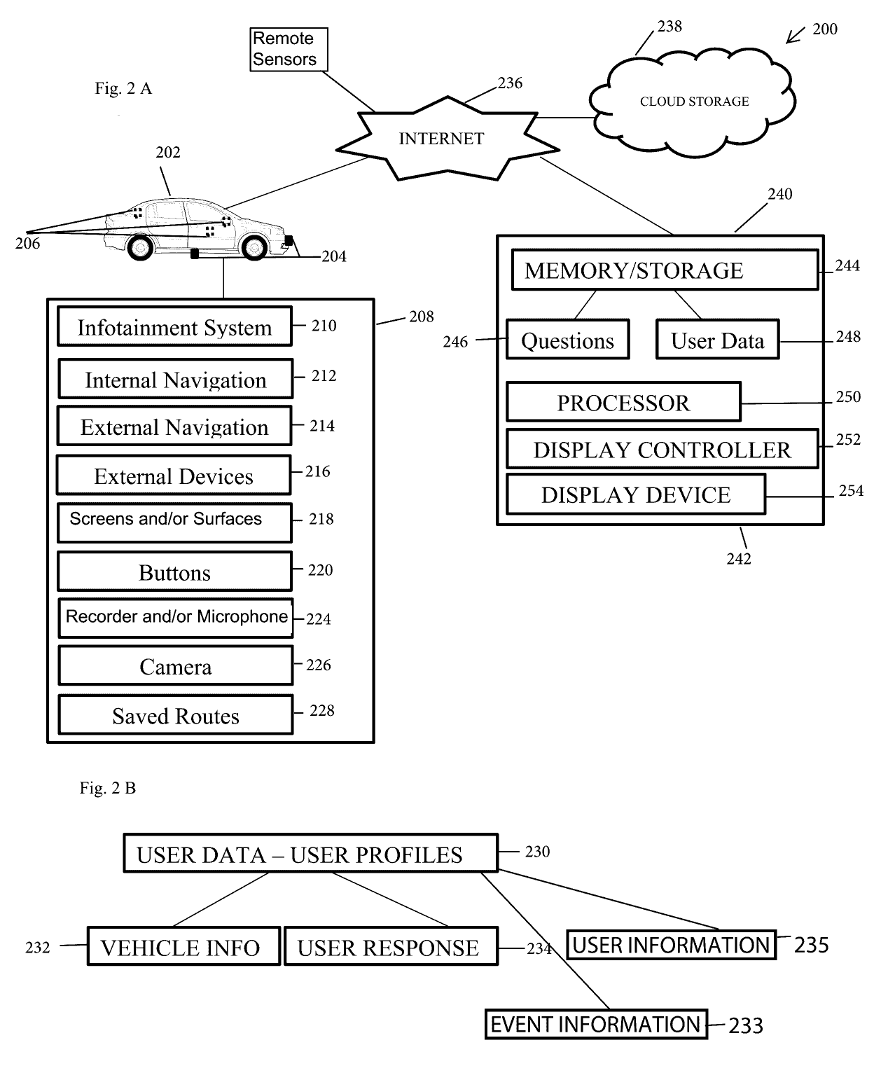

FIG. 2A depicts an exemplary vehicle survey system 200 used to administer and store survey questions and results. In this example, vehicle 202 may be outfitted with a number of sensors. This may include exterior sensors 204 and interior sensors 206. The sensors may also be remote from the vehicle and in communication with the system 200 (e.g. via the Internet 236).

The one or more sensors (e.g. 204, 206) are in communication with the vehicle 202 and are operable to measure one or more events experienced by the vehicle 202 or the users of the vehicle. Once the event occurs, the system could compile and save the information about the event as event information (FIG. 2B, 233).

Vehicle information (FIG. 2B, 232) may include vehicle speed, vehicle angular velocity, yaw rate, vehicle roll, yaw angles, global positioning (GPS coordinates), outside temperature, steering wheel angle, video information, driver response, suspension shake, exterior or external events, internal temperatures, engine RPM, seat and mirror positions, number of occupants, fuel consumption, radio station, driver alertness, interior noise, accelerometers, and the like. This could also include a time stamp, a date stamp, and a location for an event. Some vehicle information may overlap with or be similar to information about an event, while some vehicle information may not be similar to information about an event.

The system 200 may receive user response while conducting the survey. Such user response may be received by a part 208 of the vehicle. The part of the vehicle may be one of an infotainment system 210, one or more sensors (e.g 204, 206), a button 220, a camera 226, a recorder and/or microphone 224, a screen and/or other surface 218, and the like.

Additionally, such user response could be gathered by an external device 216 that is paired or linked with the vehicle 202 via the internet, Bluetooth, hard wire connection, and the like. Such paired or linked device could be an external phone that records the driver's response. The system may receive user response that may be verbal, tactile, and gestural.

When the system is activated, it may generate a survey route for the product user. The survey route could be delivered via internal navigation 212 or external navigation 214 that may be paired to the vehicle. Internal navigation 212 may have saved routes 228, which be discussed further below. Saved routes 228 are routes which are preprogrammed into the navigation system by the user.

The system 200 may incorporate external components that may be accessed via the Internet 236. Such components remote from, but in communication with, the vehicle 202 may include cloud storage 238. Remote components may also include a remote system (e.g. 240). The remote system 240 may have parts 242, such as a processor 250, a display controller 252, a display device 254, and memory or storage 244.

The memory or storage 244 may contain the database of survey questions 246. Storage 244 may also store the collected user data 248. One skilled in the art will understand that the storage 244 could also be located in the vehicle's own hardware (e.g. infotainment system 210) or in another location that is accessed via the Internet 236. In addition, other known protocols to distribute processing or provide remote access to information over a variety of network topologies including an Ethernet, Local Area Networks, Wide Area Networks, and other commonly used network topologies could be employed to connect various hardware.

As discussed with FIG. 1, the method of administering the survey may include individuals inputting survey questions and correlating events. These questions may be uploaded before the system delivers the survey questions, and/or modified at any time to update the storage 244 with new questions.

In one example, the method includes inputting a first survey question and the correlating one or more events into the survey database or storage (e.g. 244), the survey database being in communication with the vehicle. This may be done by a first individual from a first entity.

The method may further include inputting a second survey question and the correlating one or more events into the survey database by a second individual from a second entity after the step of inputting a first survey question. In this way, individuals from a different corporations and organizations could have specific questions to generate their own data. The resulting data could then be utilized by these various corporations and entities. This gives the advantage of storing and transmitting the user data 248 to various companies, third parties, and governments to improve vehicle safety, efficiency, and performance.

Vehicle information 232 available at the time a user gives a user response 234 may be correlated to each other, along with the one or more survey questions 246 that generated the response. FIG. 2B depicts that the user data may include the users' responses 234, the vehicle information 232, event information 233, and user information 235. User response 234 may be correlated with any information selected from the group consisting of vehicle information 232, user information 235, and event information 233, available via the sensors and other sources. Such information may be generated when the user response 234 was collected or generated or input into the system at any time.

Further, user data 248 may be compiled into user profiles 230. The user profiles could be used to create user contracts such that a particular user may agree to take a certain number of survey questions within a given time period (e.g. 1 survey per month). The user may receive awards as part of their contract.

The computer programming code for carrying out the operations of the vehicle survey system may be written in any combination of one or more programming languages, including an object oriented programming language such as Java, Smalltalk, C++, C# or the like. These programming languages can be written to operate on a variety of platforms such as an AIX Environment or other operating systems such as Windows 7, Linux, iOS, or Android. A preferred embodiment of the present invention is to operate on Apple's Operating System (iOS®).

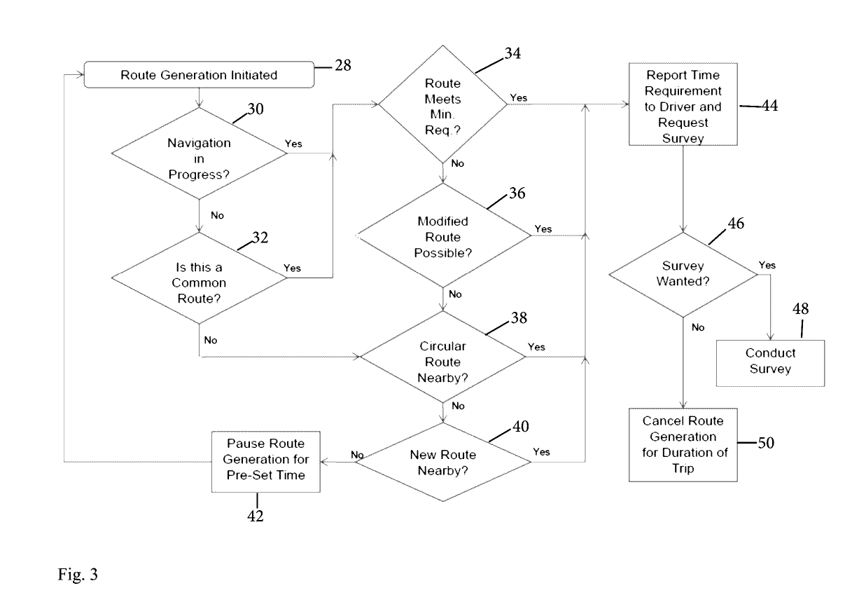

FIG. 3 depicts a more detailed flow chart of various methods of conducting the survey discussed herein. In box 28, route generation software (e.g. navigation) is initiated to deliver a survey route. In box 30, the system first determines if vehicle navigation is in progress, e.g. when the GPS navigation system in the vehicle has been programmed by the user. If yes, the system determines if the current path or route delivered by the navigation system meets or has a minimum requirement for the survey (box 34). The minimum requirement may be one or more events correlating with one or more survey questions. When the current path meets or has the minimum requirement for the survey, this path may be set as the survey route.

The event that the system would like to ask the survey questions about may be selected from a list of a vehicle speed, a stop, a noise, an intersection, a speed zone, a road condition, another vehicle, a temperature, weather, time of day, traffic or traffic conditions, steering wheel angle, a yaw angle, vehicle angular velocity, a yaw rate, vehicle roll, global positioning system coordinates, a vehicle location, a vehicle vibration, a pothole, engine RPM, a seat position, a mirror position, fuel consumption, a roundabout, other conditions external to the vehicle, and the like. The surveys may also be tailored based on the currently programmed GPS navigation route, e.g. by deleting selected questions from a survey when otherwise a minimum number of events have been correlated with the route. Questions and their events may thus be deemed optional or mandatory by the survey generators. Exemplary events will be discussed further with FIGS. 4-8.

When the current path does not have the minimum requirement for the survey, the system may proceed to step 36 to provide a first route having the minimum requirement for the survey. The first route may be automatically generated, and may be set as the survey route. The first route may be a modified form of the path that was already in progress. Subsequently, the system may deliver or output one or more survey questions while on the survey route.

The first route may be selected from a modified route (e.g. box 36), a circular route (e.g. box 38), a new route (e.g. box 40), and a saved route within the navigation system (FIG. 2A, 228). Different types of routes may be used at different times. Any of the routes delivered by the system will meet the minimum requirement(s) (e.g. having an event); therefore, the system may proceed to box 44.

In box 44, the method includes informing the user of a time requirement or duration of the first route. Because the survey route may be a modified route of the user's intended path, the survey route may take shorter or longer than the user's path. The system may wait for the user to approve the time requirement. When the user does, the method includes the step of asking the user to accept the first route take the survey while on the survey route (box 46). If the user agrees, the survey is conducted, as in box 48.

If the user deviates from the survey route while the survey is in process, the system may provide a second route being automatically generated and proceed through steps 44, 46, and 48 again. However, if no survey route is available on the deviated path, the system may cancel the route, as in box 50, or pause the survey route, as in box 42.

Surveys can be re-offered to the user at predetermined intervals. These intervals may be based on various factors such as vehicle location, condition requirements, current user, time, nearby events, and the like. Additionally survey questions can be pre-planned based on the automatically generated survey route or they can be asked spontaneously as an event arises on the survey route.

In a variation of the exemplary method discussed above, the system may determine in box 30 that navigation is not in progress. Instead, the system may determine whether the vehicle is traveling along a common route, as in box 32. Common routes are routes that the user frequently travels. The system may learn these route (e.g. daily path to work and home), and store these routes in memory. Survey questions can be administered along the common route if the common route satisfies the minimum requirement for the survey (e.g. having an event with correlated questions).

For example, the method may include determining if the vehicle is moving on a common route (box 32). If yes, the method may further include determining if the common route has the minimum requirement (box 34). If yes, the method may proceed to boxes 44-48 as above. In this case, the common route may be the survey route.

However if the answer is no, when the common route does not or fails to have the minimum requirement for the survey, the method may proceed to providing the first route being automatically generated having the minimum requirement for the survey. The first route may be selected as a survey route. As discussed above, such routes could be a modified route (e.g. box 36), circular route (e.g. box 38), a new route (e.g. box 40), and a saved route (e.g. FIG. 2A, 228).

In all embodiments, the method further comprises initiating one or more survey questions correlating to the event that is triggered while conducting the survey, box 48. For example, survey questions could ask the user to rate noise (e.g. wind noise), car start and stop, speed, acceleration, vibration, inclines, user and driver comfort, night driving, turn radius, g-force requirements, blind spot detection system, and the like. These questions may be triggered by the events. The survey questions can be a string of related questions or a standalone question, (e.g. one question per event).

Further, in another variation of the method, the system may determine if vehicle navigation is in progress on a path (box 30). If yes, this path may additionally be a common route (box 32). After each step (boxes 30, 32), the system may determine if either the path or, respectively, the common route has the minimum requirement for the survey (box 34). If neither do, the system may proceed to provide a first route having the minimum requirement for the survey (e.gs. boxes 36, 38, or 40). The system may prompt the user to select one of these provided first routes for the survey route (boxes 44-48).

FIGS. 4-8 provide exemplary maps that show different possible survey routes. In FIG. 4, this exemplary map 300 depicts a common route 54 between a first location 52 and a second location 62. The first location 52 may be the user's home and the second location 62 may be the user's work. The system may understand that the user travels this route several times per week, making it a common route.

The common route 54 may have a route portion 56 which includes a speed zone 58 with a speed 60 of 50 miles per hour. In this case, the event may be the speed zone 58. When the user is on the common route 54, the system may administer questions regarding the speed of 50 miles per hour. The system may run through method steps shown in FIG. 3 to administer the survey questions regarding speed.

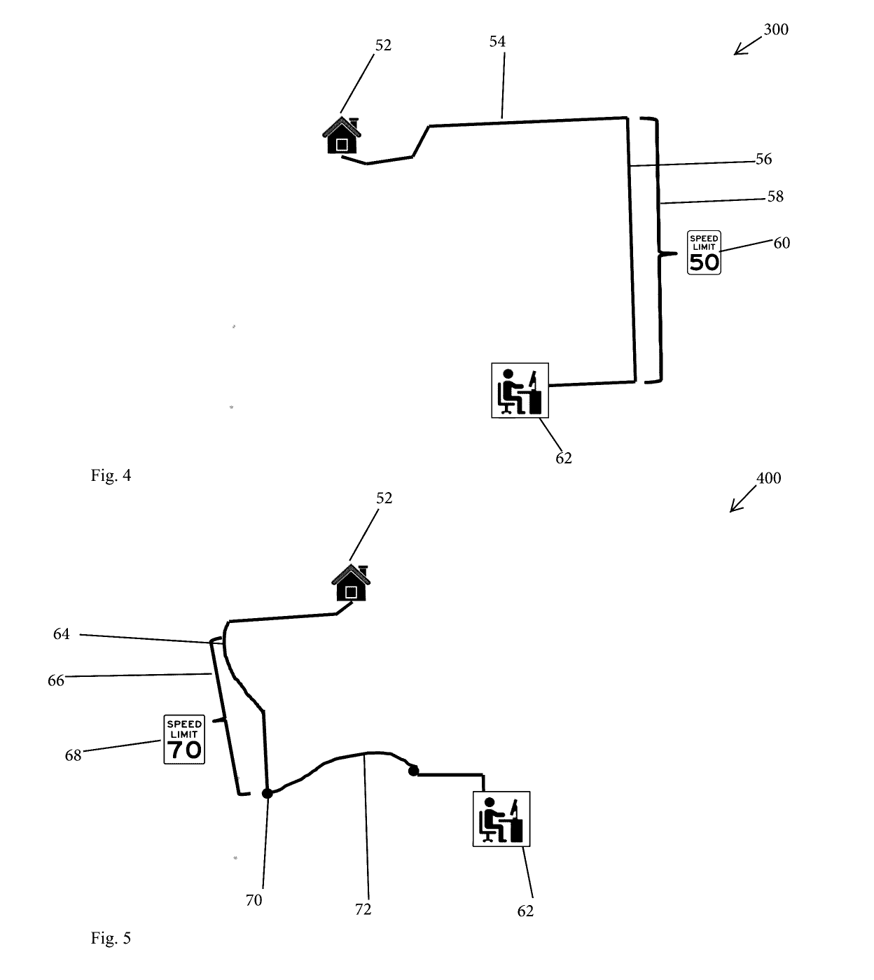

In FIG. 5 with map 400, the method may administer a survey that provides a new route 72 between the first location 52 and the second location 62. The new route 72 may be one the user has not traveled before or does not travel often. The new route may have an event of a speed 68 of 70 miles per hour, being in the route portion 64 with the speed zone 66. The new route 72 may also have a roundabout 70.

Both speed 68 and roundabout 70 may correlate to survey questions that could not be asked along the common route 54 in FIG. 4. The system may progress through the method steps shown in FIG. 3 to administer the survey of the new route 72 to collect, correlate, and transmit this user data. The system may inform the user that this route may take an additional one minute from the common route shown in FIG. 4. Additionally, this route may have two events, while the common route only had one event.

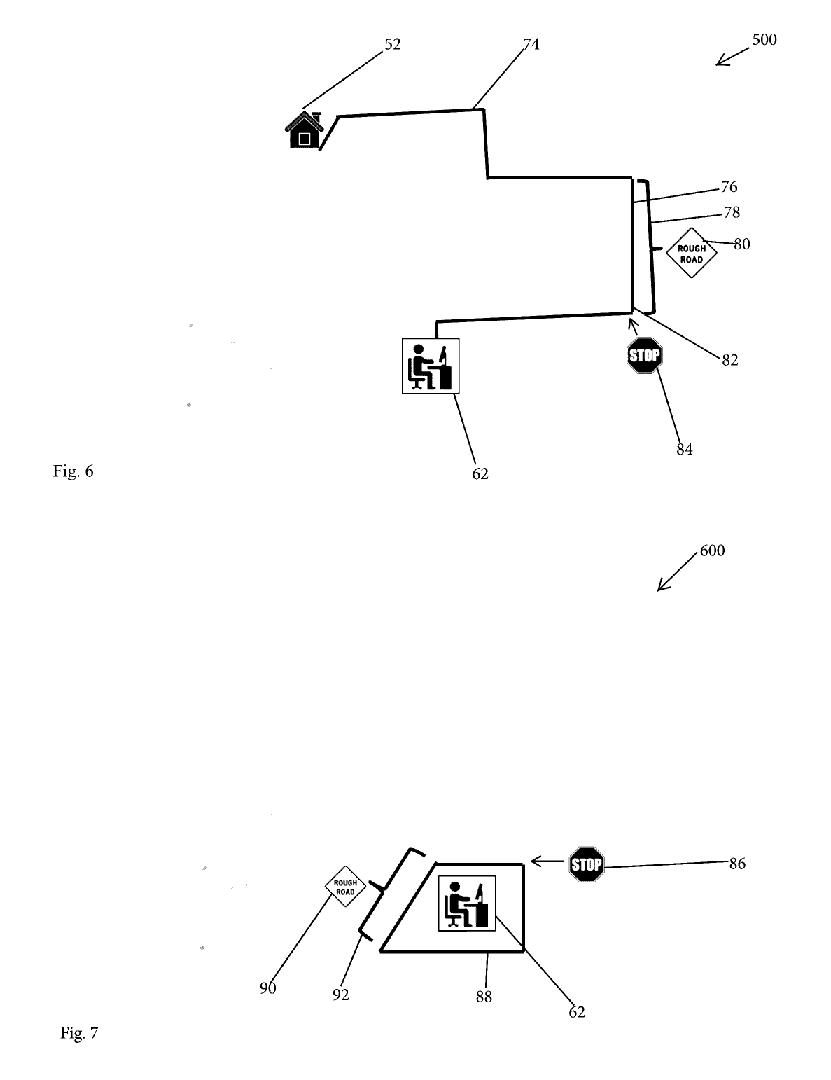

FIG. 6 has an exemplary map 500 which depicts a modified route 74. The modified route may be slightly longer than the common route of FIG. 4 between the first location 52 and the second location 62. However, the modified route 74 may only be slightly different than the common route, and may include a route portion 76 that has a rough road zone 78 of rough road 80 and a corner 82 with a stop sign 84. These events may correlate to different survey questions that the system may ask the user on modified route 74. The user response paired with respective vehicle information, event information, user information, and survey questions provides valuable feedback to the manufacturer.

FIG. 7 shows a circular route 88 around the second location 62. In this exemplary map 600, the user may not be intending to drive from a first location to a second location. However, this system may prompt the user to participate in a drive for a survey. The system may indicate that the user will end up at the starting location (e.g. second location 62), providing a circular route 88. The circular route 88 may include a stop sign 86 and a rough road zone 92 of rough road 90. The system may administer questions that correlate to those events.

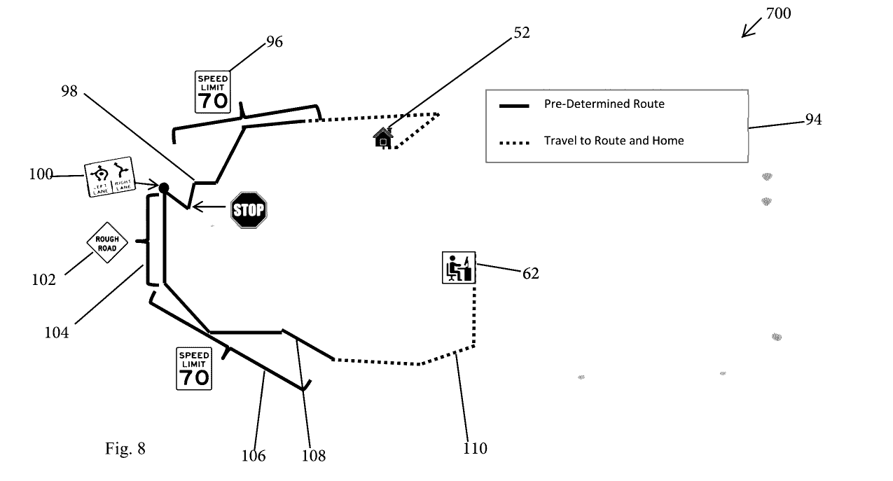

In FIG. 8, the system may generates a complex route shown on map 700, which includes a saved route 98 and a common route 110 between a first location 52 and the second location 62. Key 94 depicts that the dotted line indicates a common route 110 or route between the saved route and home. The solid line indicates the predetermined route or saved route 98, which includes several events. Those events are route portions (e.g. 108) of speed zones (e.g. 106) with speed 96, a roundabout 100, a rough road zone 104 of rough road 102, and a stop sign. As discussed with FIG. 2B, the saved route may be one that is already saved within the user's navigation.

If the user agrees to take the complex route with a combination of other routes, the system may administer survey questions regarding all events available on the route. Additionally, if spontaneous events occur on any of the above routes, the system may administer survey questions correlating to those spontaneous events as well.

The survey questions could be administered to thousands of participants, giving robust results. Because of the number of participants, one user may only have to take a portion of the survey for the manufacturer to gather the information needed. Of course, one vehicle may not encounter an event correlating with every question possible while on a survey route.

Through the above examples, an individual can add a survey question with a correlating event into a survey database being accessible to the system. When the user initiates the navigation system, the system can prompt the user to take the vehicle survey, providing them with a variety of survey routes and durations. Once accepted, the sensors can record vehicle events, the audio system can collect user response, and various parts of the system can record, store, and transmit the user data. The user data can be categorized to correlate vehicle events and the respective user response.

It should be understood that the foregoing relates to exemplary embodiments of the disclosure and that modifications may be made without departing from the spirit and scope of the disclosure as set forth in the following claims. While the disclosure has been described with respect to certain embodiments it will be appreciated that modifications and changes may be made by those skilled in the art without departing from the spirit of the disclosure.

1. A method for conducting a survey of a user with a vehicle, the method comprising:
determining if vehicle navigation is in progress on a path;
determining if the path meets a minimum requirement for the survey, the minimum requirement being an event correlating with one or more survey questions;
when the path does not meet the minimum requirement for the survey, providing a first route meeting the minimum requirement for the survey;
selecting the path or the first route as a survey route; and
delivering the one or more survey questions while on the survey route.

2. The method of claim 1 wherein the step of determining if the path meets a minimum requirement comprises the event being selected from the group consisting of a vehicle speed, a stop, a noise, an intersection, a speed zone, a road condition, another vehicle, a temperature, weather, time of day, traffic conditions, steering wheel angle, a yaw angle, vehicle angular velocity, a yaw rate, vehicle roll, global positioning system coordinates, a vehicle location, a vehicle vibration, a pothole, engine revolution per minute, a seat position, a mirror position, fuel consumption, and a roundabout.

3. The method of claim 1 wherein the step of providing the first route comprises the first route being selected from the group of a circular route, a modified route, a new route, and a saved route.

4. The method of claim 1 further comprising the step of informing the user of a time requirement or a duration of the first route.

5. The method of claim 1 wherein the step of selecting the first route as the survey route includes asking the user to accept the first route and take the survey.

6. The method of claim 1 further comprising the step of determining if the event is triggered with one or more of sensors after the step of providing a first route, the one or more sensors are in communication with the vehicle, the one or more sensors being operable to measure one or more events.

7. The method of claim 6 further comprising initiating the one or more survey questions correlating to the event after the step of determining if the event is triggered with one or more of sensors.

8. The method of claim 7 further comprising receiving and storing user response correlated with information selected from the group consisting of vehicle information, user information, and event information, defining user data, after the step of initiating the one or more survey questions, the user response being selected from the group consisting of verbal, tactile, and gestural.

9. The method of claim 8 wherein the step of receiving and storing user response comprises receiving the user response with a part of the vehicle, the part selected from the group consisting of an infotainment system, a screen, surface, a button, a camera, a microphone, and a recorder.

10. The method of claim 9 further comprising transmitting the user data after the step of receiving and storing user response.

11. The method of claim 1 further comprising the step of providing a second route, pausing the survey, or canceling the survey when the vehicle deviates from the first route after the step of providing a first route.

12. The method of claim 1 further comprising inputting a first survey question and a correlating first event into a survey database by a first individual from a first entity, the survey database being in communication with the vehicle.

13. The method of claim 12 further comprising inputting a second survey question and a correlating second event into the survey database by a second individual from a second entity after the step of inputting a first survey question.

14. A method for conducting a survey of a user with a vehicle, the method comprising:
determining if the vehicle is moving on a common route;
determining if the common route has a minimum requirement for the survey, the minimum requirement being an event correlating with one or more survey questions;
when the common route does not to have the minimum requirement for the survey, providing a first route being automatically generated and having the minimum requirement for the survey; and
selecting the common route or the first route as a survey route.

15. The method of claim 14 wherein the step of determining if the common route has a minimum requirement comprises the event being selected from the group consisting of a vehicle speed, a stop, a noise, an intersection, a speed zone, a road condition, another vehicle, a temperature, weather, time of day, traffic conditions, steering wheel angle, a yaw angle, vehicle angular velocity, a yaw rate, vehicle roll, global positioning system coordinates, a vehicle location, a vehicle vibration, a pothole, engine revolution per minute, a seat position, a mirror position, fuel consumption, and a roundabout.

16. The method of claim 14 further comprising determining if vehicle navigation is in progress before the step of determining if the vehicle is moving along a common route.

17. The method of claim 14 wherein the step of providing a first route comprises the first route being selected from the group of a circular route, a modified route, a new route, and a saved route.

18. The method of claim 15 further comprising the step of determining if the event is triggered with one or more of sensors after the step of providing a first route, the one or more sensors in communication with the vehicle, the one or more sensors being operable to measure one or more events.

19. A method for conducting a survey of a user with a vehicle, the method comprising:
determining if vehicle navigation is in progress on a path;
determining if the vehicle is moving on a common route;
determining if the path or the common route has a minimum requirement for the survey, the minimum requirement being an event correlating with one or more survey questions;
when neither the path nor the common route has the minimum requirement, providing a first route having a minimum requirement for the survey; and
selecting one of the path, the common route, and the first route as a survey route.

20. The method of claim 19 wherein the step of providing a first route comprises the event being selected from the group consisting of a vehicle speed, a stop, a noise, an intersection, a speed zone, a road condition, another vehicle, a temperature, weather, time of day, traffic conditions, steering wheel angle, a yaw angle, vehicle angular velocity, a yaw rate, vehicle roll, global positioning system coordinates, a vehicle location, a vehicle vibration, a pothole, engine revolution per minute, a seat position, a mirror position, fuel consumption, and a roundabout.
